(19) United States
(12) Patent Application Publication
(10) Pub. No.: US 2019/0179577 A1
(43) Pub. Date: Jun. 13, 2019

(54) IMAGE FORMING APPARATUS, METHOD FOR CONTROLLING IMAGE FORMING APPARATUS, AND COMPUTER READABLE RECORDING MIDEUM

(71) Applicant: Konica Minolta, Inc, Tokyo (JP)

(72) Inventor: Syunji SHIMOKAWA, Tokyo (JP)

(21) Appl. No.: 16/176,721

(22) Filed: Oct. 31, 2018

(30) Foreign Application Priority Data
Dec. 8, 2017 (JP) 2017-236067

(51) Int. Cl. G06F 3/12; H04N 1/00

(52) U.S. Cl. CPC G06F 3/126; G06F 3/1204; H04N 1/00724; H04N 1/00689; G06F 3/1205

(57) ABSTRACT

An image forming apparatus that can improve operability of a user selecting a print job from a job list is provided. The image forming apparatus includes a paper feeding tray and a processor. The paper feeding tray contains paper. The processor obtains tray paper information, which is information of paper set on the paper feeding tray, obtains job paper information from a memory that stores a job list including a plurality of print jobs associated with the job paper information, which is information of paper used at the time of output of the print jobs, and narrows down the print jobs in the job list to at least one print job for re-output based on the obtained tray paper information and job paper information.

### CROSS-REFERENCE TO RELATED APPLICATION

The entire disclosure of Japanese Patent Application No. 2017-236067, filed on Dec. 8, 2017, is incorporated herein by reference in its entirety.

### BACKGROUND

### 1. Technological Field

The present invention relates to an image forming apparatus, a method for controlling an image forming apparatus, and a computer-readable recording medium.

### 2. Description of the Related Art

There has been known an image forming apparatus that is capable of storing, in a memory, a print job output in the past, and re-outputting the print job. For example, such an image forming apparatus displays a list of all print jobs stored in a memory on an operation display, and re-outputs a print job selected by a user. See Japanese Patent Publication No. 2015-101016.

### SUMMARY

However, in the technique described above, when a large number of print jobs are included in a job list stored in the memory, information of a large number of print jobs are also displayed on the operation display. In such a case, the user needs to look for a print job to be re-output among an enormous number of candidates, which has resulted in a problem of poor operability of the user.

The present invention is made in view of the above circumstances. Therefore, an object of the present invention is to provide an image forming apparatus, a method for controlling an image forming apparatus, and a computer-readable recording medium that improve operability of a user selecting a print job from a job list.

To achieve at least one of the abovementioned objects, according to an aspect of the present invention, an image forming apparatus reflecting one aspect of the present invention, comprises: a paper feeding tray that contains paper; and a hardware processor that obtains tray paper information that is information of paper set on the paper feeding tray, obtains job paper information from a memory that stores a job list including a plurality of print jobs associated with the job paper information that is information of paper used at the time of output of the print jobs, and narrows down the print jobs in the job list to at least one print job for re-output based on the obtained tray paper information and job paper information.

To achieve at least one of the abovementioned objects, according to an aspect of the present invention, a method for controlling an image forming apparatus reflecting one aspect of the present invention and comprising a paper feeding tray that contains paper, comprises: (a) obtaining tray paper information that is information of paper set on the paper feeding tray; (b) obtaining job paper information from a memory that stores a job list including a plurality of print jobs associated with the job paper information that is information of paper used at the time of output of the print jobs; and (c) narrowing down the print jobs in the job list to at least one print job for re-output based on the tray paper information obtained in the step (a) and the job paper information obtained in the step (b).

To achieve at least one of the abovementioned objects, according to an aspect of the present invention, a non-transitory computer-readable recording medium reflecting one aspect of the present invention stores a program that causes a computer to execute the abovementioned method.

The objects, features, and characteristics of this invention other than those set forth above will become apparent from the description given herein below with reference to preferred embodiments illustrated in the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing a schematic configuration of an image forming apparatus according to a first embodiment;

FIG. 2 is a block diagram showing a functional configuration of a processor;

FIG. 3 is a diagram for explaining a relationship between a paper feeding tray and tray paper information;

FIG. 4 is a diagram showing an example of an operation screen for inputting tray paper information;

FIG. 5 is a diagram for explaining a relationship between a print job and job paper information;

FIG. 6 is a flowchart showing a procedure of processing of the image forming apparatus;

FIG. 7 is a subroutine flowchart showing a procedure of job narrowing processing of step S105 of FIG. 6;

FIG. 8 is a diagram showing an example of an operation screen for setting a job narrowing condition;

FIG. 9 is a diagram showing an example of a narrowing result table;

FIG. 10 is a subroutine flowchart showing a procedure of job displaying processing of step S106 of FIG. 6;

FIG. 11 is a diagram showing an example of an operation screen for displaying a job narrowing result;

FIG. 12 is a diagram showing a schematic configuration of an image forming apparatus according to a second embodiment;

FIG. 13 is a diagram showing another example of the operation screen for setting the job narrowing condition;

FIG. 14 is a diagram showing another example of the narrowing result table;

FIG. 15 is a diagram showing another example of the operation screen for displaying the job narrowing result;

FIG. 16 is a diagram for explaining a relationship between a print job and a plurality of pieces of the job paper information;

FIG. 17 is a flowchart showing a procedure of processing of an image forming apparatus according to a third embodiment; and

FIG. 18 is a diagram showing still another example of the operation screen for displaying the job narrowing result.

### DETAILED DESCRIPTION OF THE EMBODIMENTS

Hereinafter, one or more embodiments of the present invention will be described with reference to the drawings. However, the scope of the invention is not limited to the disclosed embodiments.

In description of the drawings, the same reference signs are attached to the same elements to avoid duplicate description. Ratios of dimensions in the drawings may be exaggerated for convenience of explanation, and different from actual ratios.

### First Embodiment

First, a configuration of an image forming apparatus according to a first embodiment will be described.

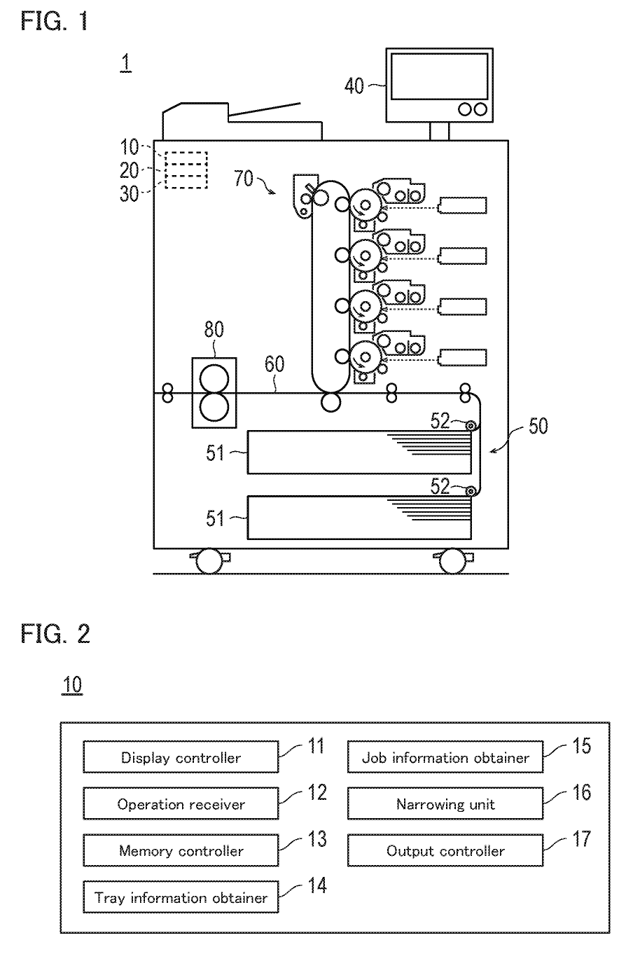

FIG. 1 is a diagram showing a schematic configuration of the image forming apparatus according to the first embodiment.

As shown in FIG. 1, the image forming apparatus 1 includes a processor 10, a memory 20, a communicator 30, an operation display 40, a paper feeder 50, a conveyor 60, an image former 70, and a fixer 80.

The processor 10 includes a CPU (central processing unit), and executes control of the each of elements described above and a variety of arithmetic processing in accordance with programs. A functional configuration of the processor 10 will be described later.

The memory 20 includes a ROM (read only memory) that stores a variety of programs and a variety of pieces of data in advance, a RAM (random access memory) that serves as a working area that temporarily stores programs and data, and a hard disk that stores a variety of programs and a variety of pieces of data, or the like.

In the present embodiment, the memory 20 stores a job list including a plurality of print jobs output in the past. However, a memory that stores the job list is not limited to the memory 20 that is locally included in the image forming apparatus 1. For example, an external memory included in another apparatus, such as an optional server or another image forming apparatus connected by a network, may be used as the memory. Hereinafter, the memory 20 or the external memory will be collectively referred to as the “memory 20 or the like” or simply the “memory”. Each print job is associated with information of paper (hereinafter also referred to as the “job paper information”) used at the time of output of the print job. A print job is associated with the job paper information and added to the job list every time the print job is output by the image forming apparatus 1.

The communicator 30 is an interface for communicating with other devices, such as a PC (personal computer) of a user, via networks, such as LAN (local area network). For example, the communicator 30 receives a print job from the PC of the user, and transmits information of an operation screen to be displayed on the PC of the user.

The operation display 40 includes a touch panel, a ten-key pad, a start button, a stop button and the like, displays a variety of pieces of information on an operation screen, and receives a variety of operations.

The paper feeder 50 includes a plurality of paper feeding trays 51 that contain paper to be used for printing, and a plurality of paper feeding rollers 52 that feed paper by separating each piece of paper from the other pieces contained in the paper feeding tray 51.

The conveyor 60 includes a conveying path, a plurality of conveying roller pairs arranged along the conveying path, and a drive motor (not shown) that drives the conveying roller pair. The conveyor 60 carries paper fed by the paper feeder 50 to the image former 70 and the fixer 80.

The image former 70 forms an image on paper based on image data included in a print job by using a well-known imaging process, such as an electrophotographic processes, including each process of charging, exposure, development, and transfer.

The fixer 80 includes a pressure roller and a heating roller. The fixer 80 heat-fixes an image by pressing and heating paper on which an image is formed by the image former 70.

The image forming apparatus 1 may include elements other than the elements described above, or does not need to include some of the elements described above.

Next, a functional configuration of the processor 10 will be described.

FIG. 2 is a block diagram showing a functional configuration of the processor.

As shown in FIG. 2, the processor 10 functions as a display controller 11, an operation receiver 12, a memory controller 13, a tray information obtainer 14, a job information obtainer 15, a narrowing unit 16, and an output controller 17, by reading programs and executing processing.

The display controller 11 causes the operation display 40 or a display of another device (for example, a PC connected to the image forming apparatus 1) (hereinafter collectively referred to as the “operation display 40 or the like”), to display a predetermined operation screen.

The operation receiver 12 receives operation input by a user on the operation display 40 or an operation unit of another device (for example, a PC connected to the image forming apparatus 1) (hereinafter collectively referred to as the “operation display 40 or the like”).

The memory controller 13 causes the memory 20 or the like to store a variety of pieces of information, and reads a variety of pieces of information from the memory 20 or the like. For example, the memory controller 13 causes the memory 20 or the like to store a print job associated with job paper information.

The tray information obtainer 14 obtains information relating to the paper feeding tray 51. For example, the tray information obtainer 14 obtains information showing that paper is set on the paper feeding tray 51, and information of paper set on the paper feeding tray 51 (hereinafter also referred to as the “tray paper information”). The tray paper information obtained by the tray information obtainer 14 is associated with each of the paper feeding trays 51, and is stored in the memory 20 functioning as a tray information memory. The tray paper information will be described later in detail.

The job information obtainer 15 obtains information relating to a print job. For example, the job information obtainer 15 obtains information relating to a print job that is output in the past and stored in the memory 20 or the like from the memory 20 or the like. The job paper information will be described later in detail.

The narrowing unit 16 narrows down print jobs in the job list stored in the memory 20 or the like to at least one print job, that is, narrows down at least one print job from the job list stored in the memory 20 or the like, based on the tray paper information obtained by the tray information obtainer 14 and the job paper information obtained by the job information obtainer 15.

The output controller 17 causes the paper feeder 50, the conveyor 60, the image former 70, the fixer 80, and the like (hereinafter also collectively referred to as the “output unit”) to output a print job.

Next, the tray paper information and the job paper information will be described in detail.

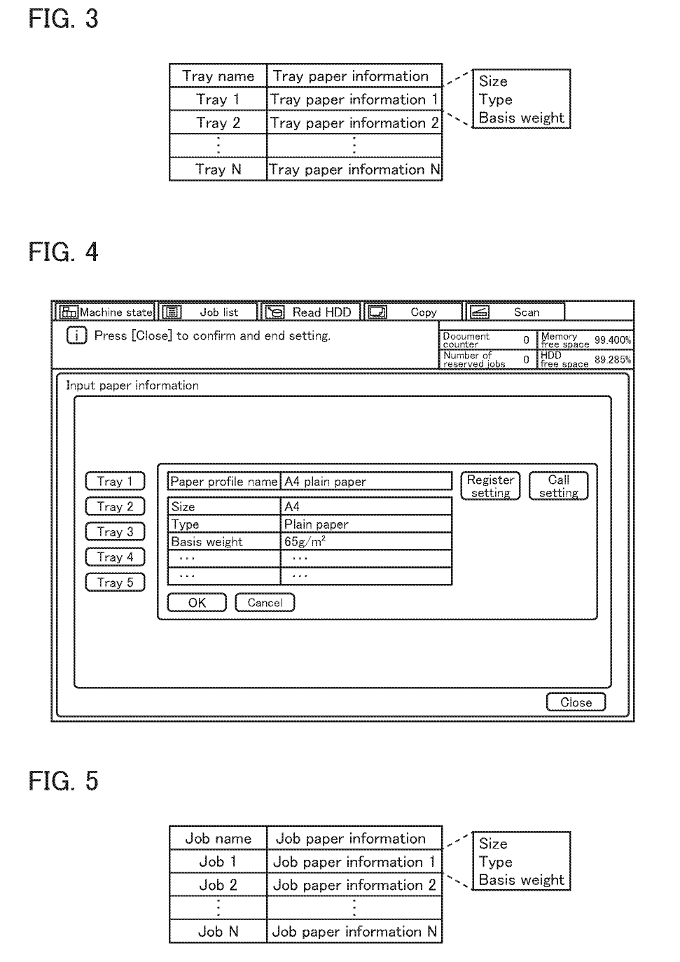

FIG. 3 is a diagram for explaining a relationship between the paper feeding tray and the tray paper information. FIG. 4 is a diagram showing an example of an operation screen for inputting the tray paper information.

As shown in FIG. 3, each piece of the tray paper information is stored in association with each of the paper feeding trays 51. Each piece of the tray paper information includes, for example, information relating to a plurality of attributes of paper, such as a size, a type, and a basis weight of paper. For example, types of paper include, without limitation to, plain paper, fine quality paper, and coated paper, and colored paper of them.

The image forming apparatus 1 displays an operation screen as exemplified in FIG. 4, for prompting the user to input the tray paper information before or after paper is set on the paper feeding tray 51. The image forming apparatus 1 then receives the tray paper information input by the user on the operation screen. For example, the tray paper information is confirmed when a soft key of “OK” is pressed, and is returned to a state immediately before when a “Cancel” key is pressed. The tray paper information input once may be stored in the memory 20 when a “Register setting” key is pressed, and may be read out from the memory 20 and re-entered when a “Call setting” key is pressed later.

When there is the tray paper information that can be automatically detected, the image forming apparatus 1 does not need to prompt the user to input the tray paper information. For example, the image forming apparatus 1 does not need to prompt the user to input a size of paper when the size of paper is a standard size that can be automatically detected, and may prompt the user to input the size of paper only when the size of paper is not the standard size. The image forming apparatus 1 may also display the tray paper information automatically detected, and prompt the user to make a correction as needed.

FIG. 5 is a diagram for explaining a relationship between a print job and the job paper information.

As shown in FIG. 5, each piece of the job paper information is stored in association with each print job output in the past. The tray paper information associated with the paper feeding tray 51 from which paper used for a print job output in the past is fed is stored as the job paper information. For this reason, each piece of the job paper information includes, for example, information relating to a plurality of attributes of paper corresponding to the tray paper information, such as a size, a type, and a basis weight of paper.

Next, a procedure of processing performed at the time of re-output of a print job of the image forming apparatus 1 according to the present embodiment will be described. Processing of the image forming apparatus 1 is processing for controlling to improve operability of a user selecting a print job from a job list stored in the memory 20 or the like.

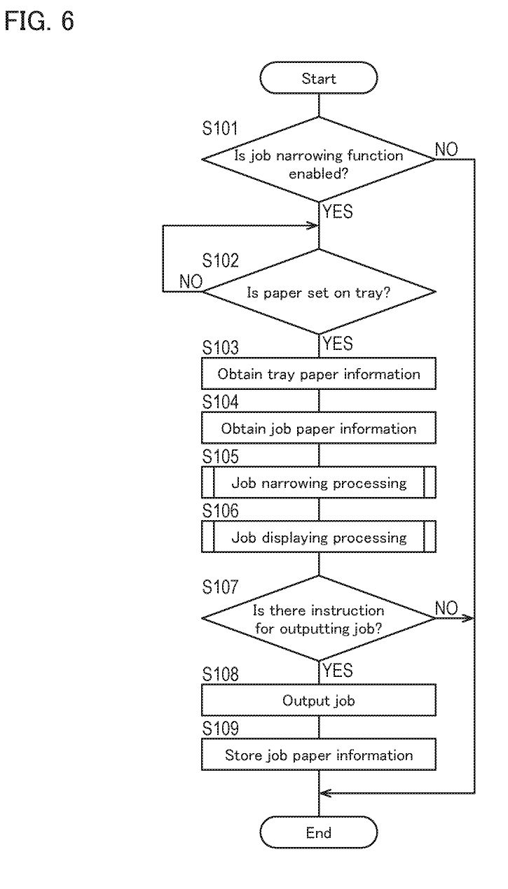

FIG. 6 is a flowchart showing a procedure of processing of the image forming apparatus. An algorithm shown in the flowchart of FIG. 6 is stored as a program in the memory 20 of the image forming apparatus 1, and is executed by the processor 10.

As shown in FIG. 6, the processor 10 first determines whether or not a job narrowing function, which is a function for narrowing down print jobs, is enabled (step S101). Before step S101, the processor 10 may function as the display controller 11 to cause the operation display 40 or the like to display an operation screen for prompting the user to set enabling or disabling of the job narrowing function, and may function as the operation receiver 12 to receive setting made by the user on the operation screen in advance. Alternatively, initial setting of enabling or disabling of the job narrowing function may be stored in the memory 20, and the processor 10 may function as the memory controller 13 to read out the initial setting.

When the job narrowing function is not enabled (step S101: NO), that is, when the job narrowing function is disabled, the processor 10 ends the processing.

When the job narrowing function is enabled (step S101: YES), the processor 10 determines whether or not paper is set on the paper feeding tray 51, that is, the paper feeding tray 51 containing paper is mounted on (inserted into) a main body of the image forming apparatus 1 (step S102).

When paper is not set on the paper feeding tray 51 (step S102: NO), the processor 10 waits until paper is set on the paper feeding tray 51.

When paper is set on the paper feeding tray 51 (step S102: YES), the processor 10 functions as the tray information obtainer 14 to obtain the tray paper information (step S103). More specifically, the processor 10 functions as the display controller 11 to cause the operation display 40 or the like to display an operation screen as exemplified in FIG. 4, for inputting the tray paper information, and functions as the operation receiver 12 to receive the tray paper information input by the user on the operation screen. The processor 10 then functions as the memory controller 13 to cause the memory 20 to store the received tray paper information, and functions as the tray information obtainer 14 to obtain the information. When displaying the operation screen after paper is set on the paper feeding tray 51, the processor 10 waits until input by the user is completed and the tray paper information can be obtained.

Next, the processor 10 functions as the job information obtainer 15 to obtain the job paper information associated with print jobs output in the past from the memory 20 or the like (step S104). The processor 10 then proceeds to job narrowing processing of step S105. The job narrowing processing is processing for narrowing down print jobs in the job list stored in the memory 20 or the like to at least one print job based on the tray paper information obtained in step S103 and the job paper information obtained in step S104. Step S105 will be described later in detail.

Next, the processor 10 proceeds to job displaying processing of step S106. The job displaying processing is processing for displaying print jobs narrowed down (obtained by narrowing down) in the job list in step S105, to the user. Step S106 will be described later in detail.

Next, the processor 10 determines whether or not there is an instruction for outputting a print job in step S106 (step S107).

When there is no instruction for outputting (step S107: NO), the processor 10 ends the processing.

When there is an instruction for outputting (step S107: YES), the processor 10 functions as the output controller 17 to cause the output unit to output (re-output) a selected print job (step S108).

Finally, the processor 10 functions as the memory controller 13 to cause the memory 20 or the like to store a new piece of the job paper information, which is information of paper used at the time of re-output of a print job, in association with the re-output print job (step S109), and ends the processing. Since the image forming apparatus 1 can re-output a print job associated with the job paper information not completely matching with the tray paper information, the job paper information at the time of re-output may be different from the job paper information before the re-output. The processor 10 may cause the memory 20 or the like to store the job paper information at the time of re-output in place of the job paper information before the re-output (for example, by overwriting), or together with the original job paper information.

Next, the job narrowing processing of step S105 will be described in detail.

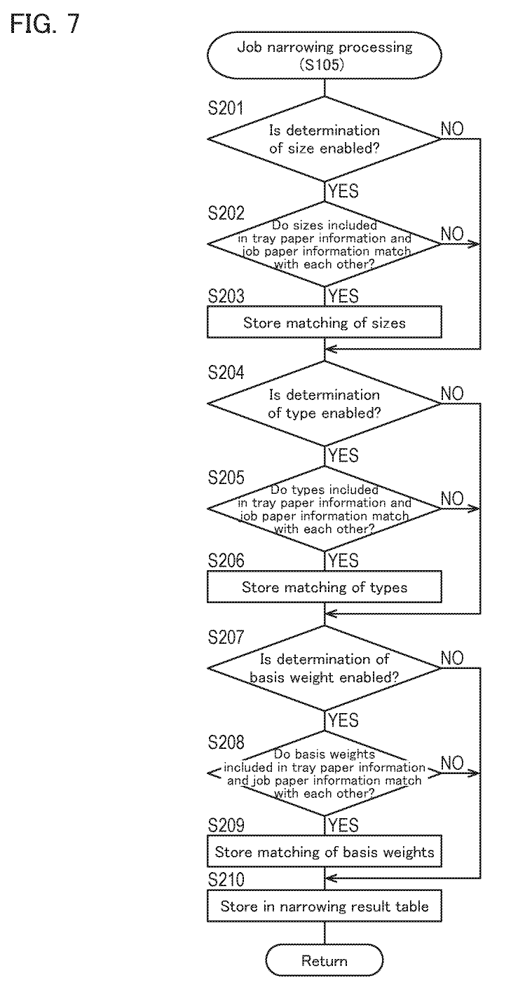

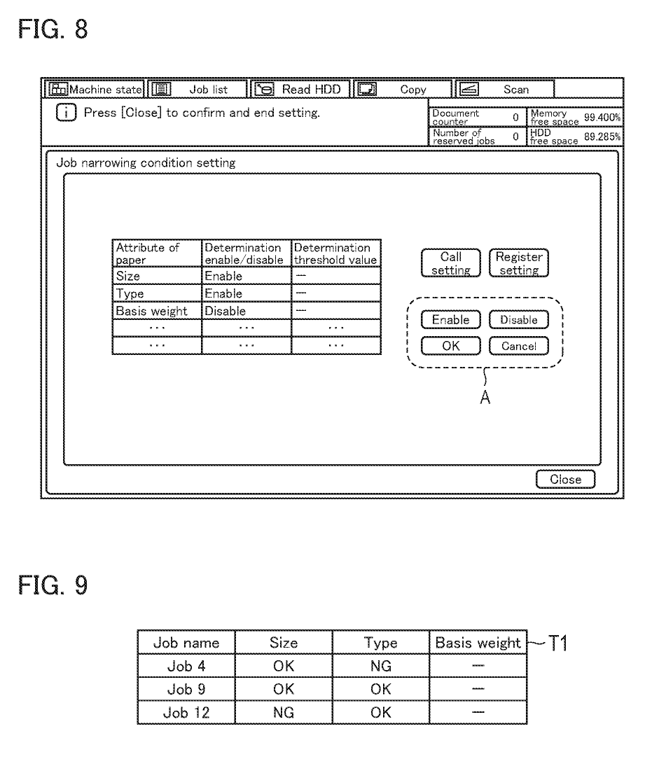

FIG. 7 is a subroutine flowchart showing a procedure of the job narrowing processing of step S105 of FIG. 6. FIG. 8 is a diagram showing an example of an operation screen for setting a job narrowing condition. FIG. 9 is a diagram showing an example of a narrowing result table. The job narrowing processing of FIG. 7 is executed simultaneously or sequentially for all print jobs included in the job list stored in the memory 20 or the like.

As shown in FIG. 7, the processor 10 first determines whether or not determination of the size of paper is enabled based on a job narrowing condition (step S201). The “job narrowing condition” is a condition showing attributes of paper to be determined in order to narrow down print jobs.

Before step S201, the processor 10 functions as the display controller 11 to cause the operation display 40 or the like to display an operation screen as exemplified in FIG. 8, for prompting the user to set the job narrowing condition. The processor 10 then functions as the operation receiver 12 to receive setting made by the user on the operation screen in advance. For example, soft keys for switching between enabling and disabling of determination are displayed in a section A when the user selects a section of “Determination enable/disable” of each attribute of paper on the operation screen. Then, for example, setting of “Enable” or “Disable” is confirmed when an “OK” key is pressed in a state where an “Enable” or “Disable” key is selected, and is returned to a state immediately before when a “Cancel” key is pressed. Initial setting of the job narrowing condition may be stored in the memory 20 or the like.

The description will be made on FIG. 7 again. When the determination of the size of paper is enabled (step S201: YES), the processor 10 functions as the narrowing unit 16 to determine whether or not the size of paper included in the tray paper information matches with the size of paper included in the job paper information (step S202).

When the sizes of paper match with each other (step S202: YES), the processor 10 functions as the memory controller 13 to cause the memory 20 to store information indicating that the sizes of paper match with each other (step S203). The processor 10 then proceeds to processing of step S204.

When the determination of the size of paper is disabled (step S201: NO), or the sizes of paper do not match with each other (step S202: NO), the processor 10 proceeds to processing of step S204 directly.

Next, the processor 10 executes processing of steps S204 to S206 for the type of paper, and processing of steps S207 to S209 for the basis weight of paper. Procedures of processing of steps S204 to S206 and steps S207 to S209 are substantially the same as those of steps S201 to S203, and will be omitted from description.

Finally, the processor 10 functions as the memory controller 13 to cause the memory 20 to store names of print jobs associated with the job paper information including attributes of paper, at least part of which matches with attributes of paper included in the tray paper information (step S210). That is, the processor 10 causes a narrowing result table T1 as exemplified in FIG. 9, to store names (identifiers) of print jobs narrowed down based on the job narrowing condition, among print jobs included in the job list. The processor 10 also reflects a result stored in the memory 20 in steps S203, S206, and S209 to the narrowing result table T1. In the narrowing result table T1, “OK” signifies that attributes of paper included in the tray paper information and the job paper information match with each other, “NG” signifies that such attributes do not match with each other, and “−” signifies that determination of attributes of paper is disabled.

The processor 10 may cause the narrowing result table T1 to store names of print jobs only when at least sizes of paper included in the tray paper information and the job paper information match with each other. This is because a possibility is extremely low that a print job associated with the size of paper that does not match with the size of paper set on the paper feeding tray 51 is re-output by the user.

Next, the job displaying processing of step S106 will be described in detail.

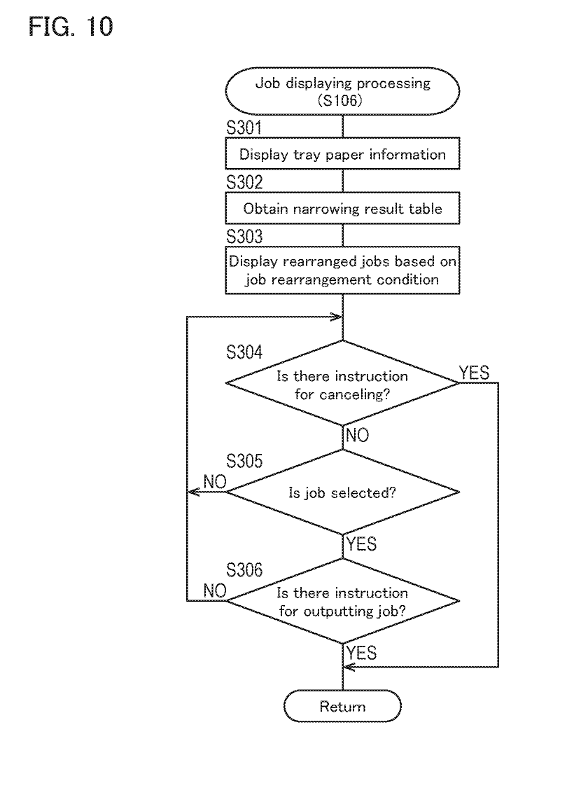

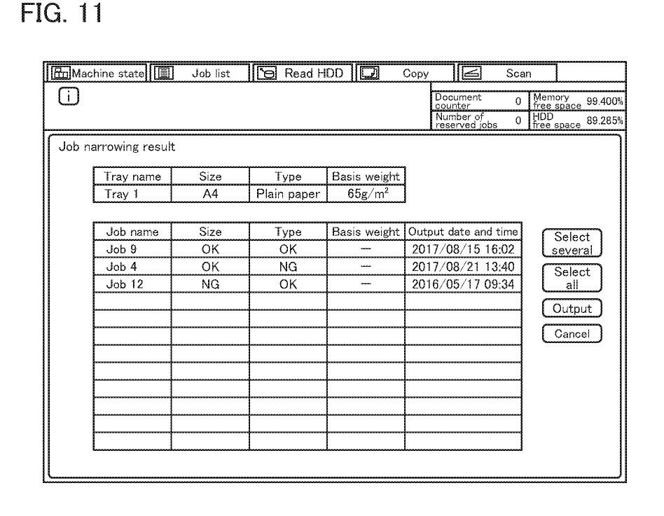

FIG. 10 is a subroutine flowchart showing a procedure of the job displaying processing of step S106 of FIG. 6. FIG. 11 is a diagram showing an example of an operation screen for displaying a job narrowing result.

As shown in FIG. 10, the processor 10 first functions as the display controller 11 to cause the operation display 40 or the like to display the tray paper information that is obtained in step S103 and subject to comparison in the job narrowing processing of step S105 (step S301). The processor 10 then functions as the memory controller 13 to obtain the narrowing result table T1 in which names of print jobs and the like are stored in step S210 (step S302). Further, the processor 10 functions as the display controller 11 to cause the operation display 40 or the like to display an operation screen on which print jobs are rearranged based on a job rearrangement condition (step S303). The “job rearrangement condition” is a condition for rearranging print jobs so that, for example, priority is placed on the print jobs stored in association with the job paper information that matches with the tray paper information with a high degree of coincidence. Alternatively, the “job rearrangement condition” may be a condition for rearranging print jobs in accordance with other conditions, such as date and time of output.

The processor 10 causes the operation display 40 or the like to display an operation screen as exemplified in FIG. 11, for displaying the job narrowing result to the user. The operation screen of FIG. 11 displays the tray paper information obtained in step S103 and information of narrowed-down print jobs, and the order of print jobs is rearranged as compared with that in the narrowing result table T1 of FIG. 9. This shows a result of the processor 10 rearranging print jobs so that priority is placed on the print jobs that are stored in association with the job paper information that matches with the tray paper information with a high degree of coincidence. When there are a plurality of print jobs associated with the job paper information that matches with the tray paper information with an equivalent degree of coincidence, like Job 4 and Job 12, the image forming apparatus 1 may further rearrange the print jobs in order of date and time of output.

The description will be made on FIG. 10 again. The processor 10 determines whether or not there is an instruction for canceling current processing (step S304). For example, the processor 10 functions as the operation receiver 12 to determine whether or not a soft key of “Cancel” for ending current processing is pressed on an operation screen, such as one shown in FIG. 11.

When there is an instruction for canceling (step S304: YES), the processor 10 returns to the processing of FIG. 6.

When there is no instruction for canceling (step S304: NO), the processor 10 determines whether or not at least one print job is selected (step S305). For example, the processor 10 functions as the operation receiver 12 to determine whether or not a section of “Job name” of each print job is selected on the operation screen, such as one shown in FIG. 11.

When no print job is selected (step S305: NO), the processor 10 repeats the processing of step S304 and S305 until there is an instruction for canceling or at least one print job is selected.

When at least one print job is selected (step S305: YES), the processor 10 determines whether or not there is an instruction for outputting a print job (step S306). For example, the processor 10 functions as the operation receiver 12 to determine whether or not a soft key of “Output” for outputting a selected print job is pressed on the operation screen, such as one shown in FIG. 11.

When there is an instruction for outputting (step S306: YES), the processor 10 returns to the processing of FIG. 6.

When there is no instruction for outputting (step S306: NO), the processor 10 repeats the processing of step S304 to S306 until there is an instruction for canceling or an instruction for outputting.

When a predetermined timeout period elapses without no instruction for canceling or no instruction for outputting, the processor 10 may deem that there is an instruction for canceling and return to the processing of FIG. 6.

As described above, the image forming apparatus 1 narrows down print jobs in the job list to at least one print job based on the tray paper information, which is information of paper set on the paper feeding tray 51, and the job paper information, which is information of paper used at the time of output of print jobs. Accordingly, the image forming apparatus 1 can narrow down print jobs in the job list only to print jobs that can be re-output by using paper contained in the paper feeding tray 51, even when a large number of print jobs are stored in the memory 20 or the like. In this manner, the image forming apparatus 1 can improve operability of the user selecting a print job from the job list.

The image forming apparatus 1 also obtains the tray paper information input by the user on the operation screen. In this manner, the image forming apparatus 1 can obtain the tray paper information without the need of a special configuration.

The image forming apparatus 1 also narrows down print jobs in the job list at a timing at which paper is set on the paper feeding tray 51. In this manner, the image forming apparatus 1 can automatically execute the job narrowing processing without waiting for a special operation performed by the user, which results in further improvement in operability of the user selecting a print job from the job list.

The image forming apparatus 1 also narrows down print jobs in the job list based on the job narrowing condition. In this manner, the image forming apparatus 1 can effectively execute the job narrowing processing based on the job narrowing condition.

The job narrowing condition is set by the user. In this manner, the image forming apparatus 1 can effectively execute the job narrowing processing based on requests from the user.

The image forming apparatus 1 also narrows down print jobs in the job list based on whether or not attributes of paper to be determined included in the tray paper information and the job paper information match with each other. In this manner, the image forming apparatus 1 can narrow down print jobs in the job list only to print jobs associated with the job paper information at least part of which matches with the tray paper information.

The image forming apparatus 1 also rearranges print jobs based on the job rearrangement condition when there is a plurality of narrowed-down print jobs. In this manner, the image forming apparatus 1 can display print jobs which are rearranged in the order preferable to the user, which results in further improvement in operability of the user selecting a print job from the job list.

The job rearrangement condition is a condition for rearranging print jobs so that priority is placed on the print jobs stored in association with the job paper information that matches with the tray paper information with a high degree of coincidence. In this manner, the image forming apparatus 1 can display print jobs so that priority is placed on the print jobs which have a high possibility of being re-output by the user. The image forming apparatus 1 can also display print jobs stored in association with the job paper information that does not completely, but partly, match with the tray paper information by placing a lower degree of priority.

The image forming apparatus 1 also adds a print job that is associated with the job paper information to the job list every time the print job is output. In this manner, the image forming apparatus 1 can make all print jobs which have been output before, subject to re-output. In addition, the image forming apparatus 1 can cause, not only in the memory 20 of the own apparatus, but also in a memory of other apparatuses, such as a server, to store print jobs. Accordingly, the image forming apparatus 1 can share the job paper information with other image forming apparatuses, which results in improvement in operability of the user using a plurality of image forming apparatuses.

When re-outputting a print job, the image forming apparatus 1 also stores the job paper information at the time of the re-output in association with the re-output print job on the memory 20 or the like. In this manner, the image forming apparatus 1 can execute the subsequent job narrowing processing based on the job paper information at the time of re-output.

In the above embodiment, an example of the processing of the image forming apparatus 1 is described. However, the present embodiment is not limited to the above example. Various modifications, improvements or the like, such as those described below, can be made.

The image forming apparatus 1 narrows down print jobs in the job list at a timing at which paper is set on the paper feeding tray 51 in step S102 of FIG. 6. However, the present embodiment is not limited to the above example. The image forming apparatus 1 may execute the job narrowing processing at other timings.

As described above, the image forming apparatus 1 stores the obtained tray paper information in association with the paper feeding tray 51. For this reason, the image forming apparatus 1 does not require the user to re-enter the tray paper information even when executing the job narrowing processing at a timing different from the timing at which paper is set on the paper feeding tray 51.

For example, the image forming apparatus 1 may narrow down print jobs in the job list at a timing at which the paper feeding tray 51 is selected on an operation screen displayed on the operation display 40 or the like. For example, the image forming apparatus 1 displays, on the operation display 40 or the like, an operation screen for prompting the user to select the paper feeding tray 51 containing paper to be used. The image forming apparatus 1 then determines whether or not the paper feeding tray 51 is selected by the user on the operation screen in place of performing the processing of step S102. When the paper feeding tray 51 is selected, the image forming apparatus 1 executes the processing of steps S103 to S109. In this manner, every time a different one of the paper feeding tray 51 is selected on the operation screen for selecting the paper feeding tray 51, the image forming apparatus 1 can present to the user print jobs that can be re-output by using paper contained in the selected paper feeding tray 51, which results in further improvement in operability of the user.

Alternatively, the image forming apparatus 1 may narrow down print jobs in the job list at a timing at which an operation screen for prompting the user to select a print job to be re-output is displayed. The operation screen may be, for example, an operation screen that is displayed when a “Job list” tab is selected on an operation screen, such as one shown in FIG. 4. The image forming apparatus 1 determines whether or not the “Job list” tab is selected. When the “Job list” tab is selected, the image forming apparatus 1 executes the processing of steps S103 to S109. The image forming apparatus 1 may further display an operation screen for prompting the user to select the paper feeding tray 51, for which the job narrowing processing is to be performed, before or after displaying the operation screen for selecting a print job. As described above, the image forming apparatus 1 can execute the job narrowing processing at various timings.

The image forming apparatus 1 determines whether or not types of paper included in the tray paper information and the job paper information match with each other in step S205 of FIG. 7. The image forming apparatus 1 may determine that the types of paper included in the tray paper information and the job paper information match with each other even when the types of paper do not completely match with each other and partly match with each other.

As described above, types of paper include, for example, plain paper, fine quality paper, and coated paper, and colored paper of them. Accordingly, for example, when a type of paper included in the tray paper information is “white plain paper” and a type of paper included in the job paper information is “white fine quality paper”, colors of paper match with each other while materials of paper do not match with each other. In this case, in step S205, the image forming apparatus 1 may determine that the types of paper match with each other in order to obtain as many narrowed-down print jobs as possible, or may determine that the types of paper do not match with each other in order to narrow down print jobs as accurately as possible. Alternatively, in the job narrowing processing, the image forming apparatus 1 may determine a color and a material of paper separately as different attributes of paper instead of determining a color and a material of paper collectively as one attribute, which is the type, of paper.

The image forming apparatus 1 determines whether or not basis weights of paper included in the tray paper information and the job paper information match with each other in step S208 of FIG. 7. However, the present embodiment is not limited to the above example. The image forming apparatus 1 may determine that the basis weights of paper included in the tray paper information and the job paper information match with each other even when the basis weights of paper do not completely match with each other, as long as a difference between the basis weights is a predetermined threshold value for determination or smaller. The predetermined threshold value for determination may be settable by the user on an operation screen, such as one shown in FIG. 8.

### Second Embodiment

In the description of the first embodiment, the image forming apparatus 1 obtains the tray paper information input by the user. In a second embodiment, the image forming apparatus 1 obtains the tray paper information by another method.

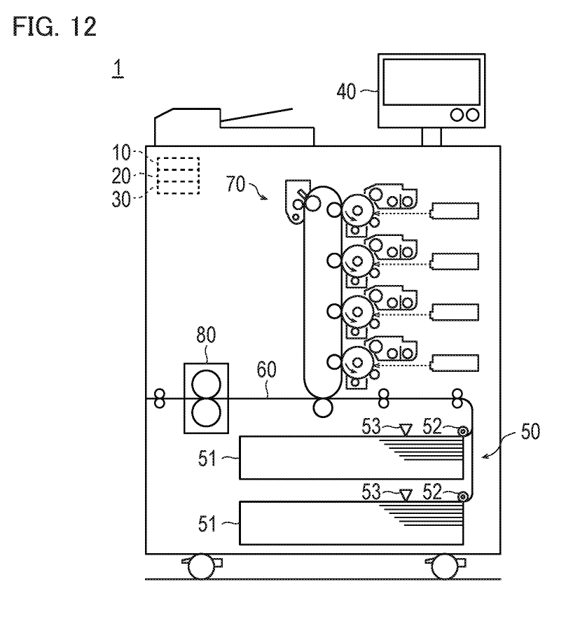

FIG. 12 is a diagram showing a schematic configuration of an image forming apparatus according to the second embodiment.

As shown in FIG. 12, the image forming apparatus 1 according to the second embodiment has a configuration substantially the same as the image forming apparatus 1 according to the first embodiment, except a sensor 53.

For example, the sensor 53 is provided above the paper feeding tray 51, and detects information of paper set on the paper feeding tray 51 (tray paper information). The tray paper information according to the second embodiment may include information that is different from the tray paper information according to the first embodiment. The tray paper information according to the second embodiment includes, for example, information relating to a plurality of attributes of paper, such as a size, a thickness, a surface smoothness, and a glossiness of paper.

The sensor 53 may be configured with a plurality of types of sensors. For example, the sensor 53 may be configured with a plurality of types of sensors dedicated for detecting a size, a thickness, a surface smoothness, a glossiness, and the like of paper respectively. Alternatively, the sensor 53 may include, for example, an optical sensor or the like that can measure both a surface smoothness and a glossiness of paper. When a size of paper is a standard size that is automatically detectable, the image forming apparatus 1 does not need to cause the sensor 53 to detect the size of paper.

Before the sensor 53 detects a thickness of paper, the paper feeding roller 52 may move a position of a top piece of paper contained in the paper feeding tray 51, and after the sensor 53 detects the thickness of the piece of paper, the paper feeding roller 52 may return the piece of paper to an original position. Alternatively, a sensor that detects the thickness of paper in the sensor 53 may be provided on the conveying path of the conveyor 60 to detect the thickness of paper carried by the conveyor 60.

Next, a procedure of processing of the image forming apparatus 1 according to the second embodiment will be described. Hereinafter, only processing different from the processing of the image forming apparatus 1 according to the first embodiment will be described.

In the second embodiment, in step S103 of FIG. 6, the image forming apparatus 1 obtains the tray paper information detected by the sensor 53 instead of the tray paper information input by the user. In addition, the image forming apparatus 1 displays an operation screen different from one in the first embodiment on the operation display 40 or the like before step S201 of FIG. 7.

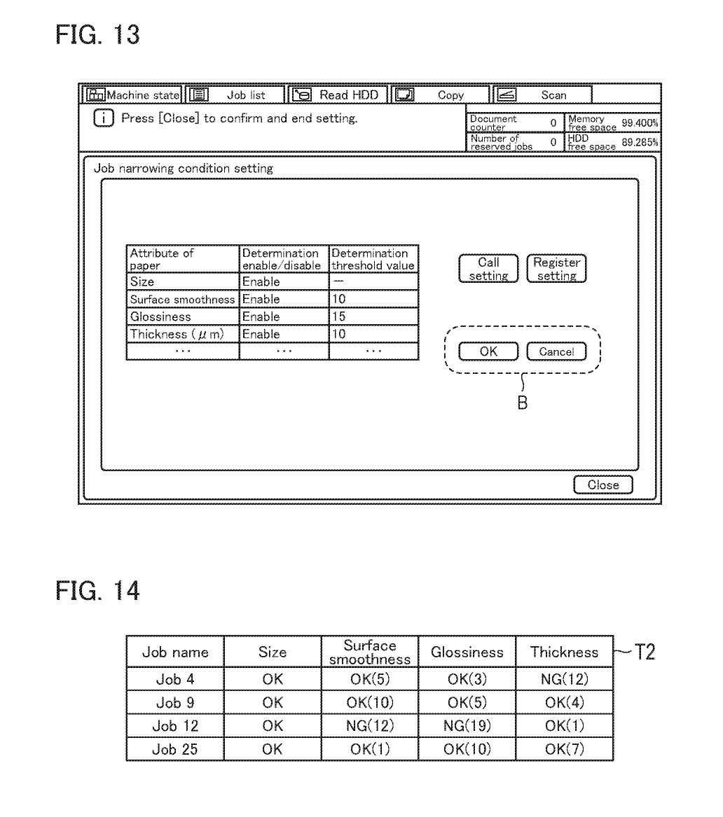

FIG. 13 is a diagram showing another example of the operation screen for setting the job narrowing condition.

For example, the image forming apparatus 1 may also receive input of a “Determination threshold value (threshold value for determination)” in addition to selection of the “Determination enable/disable” made by the user on an operation screen as exemplified in FIG. 13, for prompting the user to set the job narrowing condition. For example, when a threshold value for determination for each attribute of paper is input, the image forming apparatus 1 displays a soft key in a section B. For example, the threshold value for determination is confirmed when an “OK” key is pressed, and is returned to a state immediately before when a “Cancel” key is pressed. That is, the “job narrowing condition” in the second embodiment can be considered as a condition showing attributes of paper to be determined in order to narrow down print jobs, and a condition relating to the threshold value for determination. An initial value of the threshold value for determination may be stored in the memory 20 or the like.

In the job narrowing processing of FIG. 7, the image forming apparatus 1 makes determination relating to the tray paper information according to the second embodiment, such as a size, a thickness, a surface smoothness, a glossiness of paper, instead of the tray paper information according to the first embodiment, such as a size, a type, a basis weight of paper. When the threshold value for determination is input, the image forming apparatus 1 may determine that attributes of paper included in the tray paper information and the job paper information match with each other even when numerical values showing the attributes of paper do not completely match with each other, as long as a difference between the numerical values is a threshold value for determination or smaller. In addition, in the job displaying processing of FIG. 10, the image forming apparatus 1 displays the tray paper information according to the second embodiment, such as a size, a thickness, a surface smoothness, a glossiness of paper, instead of the tray paper information according to the first embodiment, such as a size, a type, a basis weight of paper.

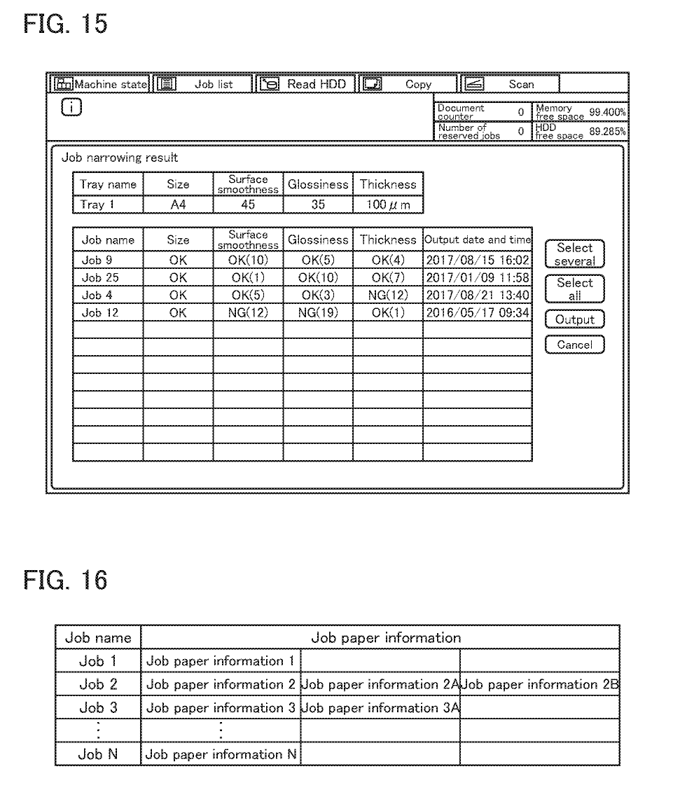

FIG. 14 is a diagram showing another example of the narrowing result table. FIG. 15 is a diagram showing another example of the operation screen for displaying the job narrowing result.

In step S210 of FIG. 7, the image forming apparatus 1 stores names of print jobs associated with the job paper information, at least part of which matches with the tray paper information, in a narrowing result table T2 as exemplified in FIG. 14. A result of determination as to whether or not a difference between a numerical value showing an attribute of paper included in the tray paper information and a numerical value showing an attribute of paper included in the job paper information is the threshold value for determination or smaller, as well as a difference value (a parenthesized numerical value in FIG. 14) may be stored in the narrowing result table T2.

In step S303 of FIG. 10, the image forming apparatus 1 displays an operation screen as exemplified in FIG. 15, for displaying the job narrowing result on the operation display 40 or the like. On the operation screen of FIG. 15, the tray paper information obtained in step S103 and information of narrowed-down print jobs are displayed so that priority is placed on the print jobs stored in association with the job paper information that matches with the tray paper information with a higher degree of coincidence. The image forming apparatus 1 can display whether or not a difference is the threshold value for determination or smaller as well as a difference value (a parenthesized numerical value), which results in a significant improvement in operability of the user selecting a print job to be re-output in consideration of a difference.

In the operation screen of FIG. 15, a result of determination and a difference value are displayed at the same time. However, the present embodiment is not limited to this example. The image forming apparatus 1 may display only a result of determination or only a difference value. Alternatively, display of a result of determination and display of a difference value may be switchable by an optional soft key or the like.

As described above, the image forming apparatus 1 according to the second embodiment obtains the tray paper information detected by the sensor 53. In this manner, the image forming apparatus 1 can obtain the tray paper information without the need of inputting the tray paper information by the user, which results in a further improvement in convenience of the user.

The image forming apparatus 1 according to the second embodiment narrows down print jobs in the job list based on whether or not a difference between a numerical value showing an attribute of paper to be determined included in the tray paper information and a numerical value showing an attribute of paper to be determined included in the job paper information is the predetermined threshold value for determination or smaller. In this manner, the image forming apparatus 1 can determine that attributes of paper included in the tray paper information and the job paper information match with each other even when the attributes of paper do not completely match with each other, as long as a difference is a threshold value for determination or smaller. Accordingly, the image forming apparatus 1 can execute the narrowing processing in a more flexible manner.

The configurations and processing according to the first embodiment and the second embodiment may be used in combination. That is, the image forming apparatus 1 may obtain both the tray paper information input by the user and the tray paper information detected by the sensor 53, and may narrow down print jobs in the job list based on both pieces of the tray paper information. In other words, the image forming apparatus 1 may receive, on the operation screen for setting the job narrowing condition, selection of “Determination enable/disable” and/or the “Determination threshold value” input by the user with respect to each of a size of paper automatically detected, a type and a basis weight of paper input by the user, and a surface smoothness, a glossiness, and a thickness of paper detected by the sensor 53. In this manner, the image forming apparatus 1 can narrow down print jobs in the job list based on detailed requests from the user.

The image forming apparatus 1 according to the second embodiment may obtain, as the tray paper information, a surface smoothness, a glossiness, a thickness, and the like of paper input by the user, instead of a surface smoothness, a glossiness, a thickness, and the like of paper detected by the sensor 53. In this manner, the image forming apparatus 1 can obtain, as the tray paper information, a surface smoothness, a glossiness, a thickness, and the like of paper measured by the user using optional sensors.

### Third Embodiment

The above embodiments describe the processing that is performed when one piece of the job paper information is associated with one print job included in the job list. A third embodiment describes processing that is performed when a plurality of pieces of the job paper information are associated with one print job included in the job list.

FIG. 16 is a diagram for explaining a relationship between a print job and a plurality of pieces of the job paper information.

As shown in FIG. 16, each piece of the job paper information is stored in association with each print job output in the past. Three different pieces of the job paper information are associated with Job 2, and two different pieces of the job paper information are associated with Job 3. When a print job is output by using a plurality of types of paper between which at least one attribute of paper is different, a plurality of pieces of the job paper information are associated with the print job.

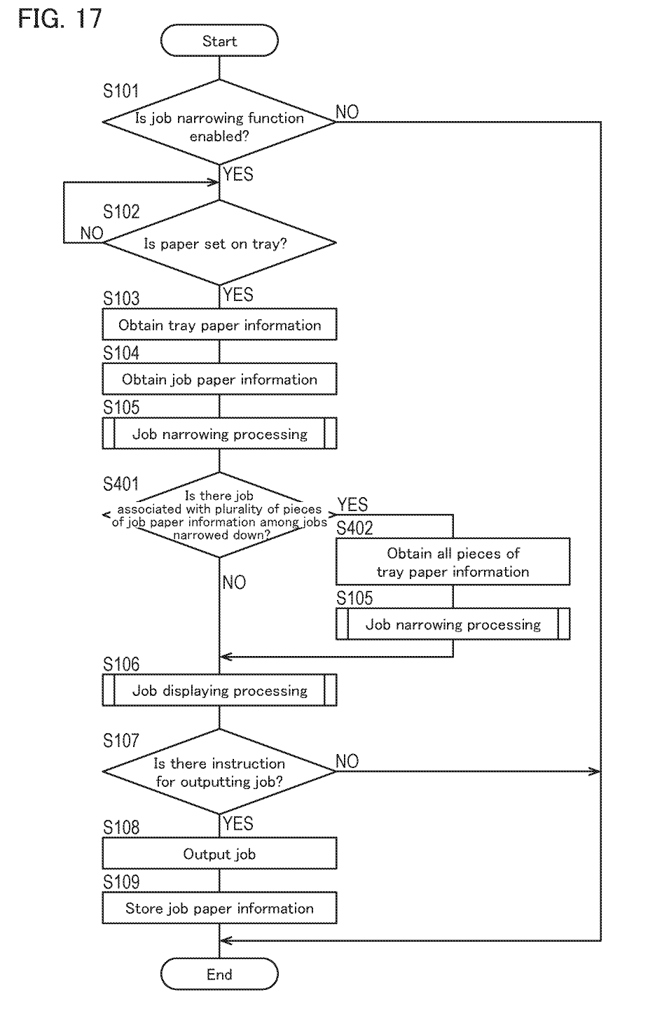

FIG. 17 is a flowchart showing a procedure of processing of the image forming apparatus according to the third embodiment. The processing of steps S101 to S109 of FIG. 17 is similar to the processing of steps S101 to S109 of FIG. 6, and will be omitted from description. When a plurality of pieces of the job paper information are associated with one print job, the image forming apparatus 1 may execute the job narrowing processing of step S105 for any piece of the job paper information.

After the job narrowing processing of step S105, the image forming apparatus 1 executes processing of step S401 before the job displaying processing of step S106. That is, the processor 10 of the image forming apparatus 1 functions as the narrowing unit 16 to determine whether or not there is a print job associated with a plurality of different pieces of the job paper information among print jobs narrowed down in the job list in step S105 (step S401).

When there is no print job associated with a plurality of different pieces of the job paper information (step S401: NO), the image forming apparatus 1 proceeds to the processing of step S106, and executes processing similar to that in the first embodiment or the second embodiment.

When there is a print job associated with a plurality of different pieces of the job paper information (step S401: YES), the image forming apparatus 1 proceeds to processing of step S402. The image forming apparatus 1 then obtains information of paper set on all the paper feeding trays 51 (all pieces of the tray paper information) stored in the memory 20 functioning as a tray information memory (step S402). As described above, every time paper is set on the paper feeding trays 51, the tray paper information obtained by the tray information obtainer 14 is associated with each of the paper feeding trays 51, and is stored in the memory 20 functioning as a tray information memory.

Next, the image forming apparatus 1 proceeds to the job narrowing processing of step S105 again. The image forming apparatus 1 then executes the processing of steps S201 to S210 for each combination of the job paper information not determined previously among a plurality of different pieces of the job paper information associated with a print job and all pieces of the tray paper information. That is, the image forming apparatus 1 determines whether or not at least part of the job paper information not determined previously matches with any piece of the tray paper information. Alternatively, the image forming apparatus 1 determines whether or not a difference between a numerical value showing an attribute of paper included in any piece of the tray paper information and a numerical value showing an attribute of paper included in the job paper information not determined previously is a predetermined threshold value for determination or smaller. When there are a plurality pieces of the tray paper information at least part of which matches with the job paper information not determined previously, the image forming apparatus 1 may determine the tray paper information having a highest degree of coincidence as the tray paper information that matches with the job paper information. After the above, the image forming apparatus 1 adds a result of the determination to the narrowing result table, and proceeds to the processing of step S106.

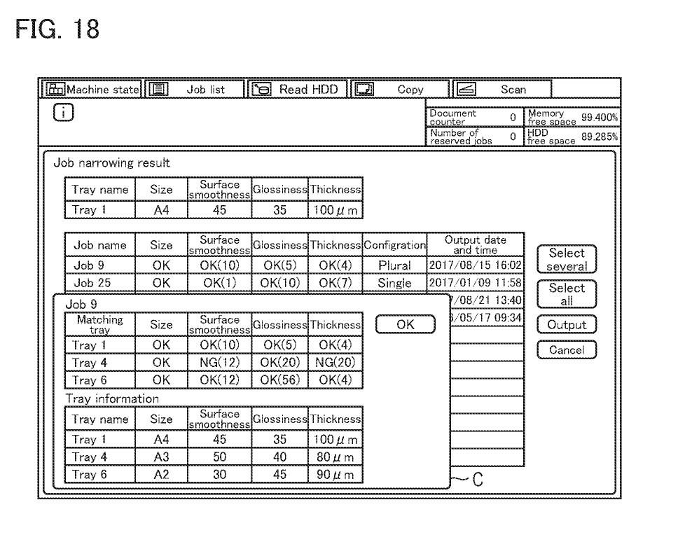

FIG. 18 is a diagram showing still another example of the operation screen for displaying the job narrowing result.

The image forming apparatus 1 displays an operation screen as exemplified in FIG. 18, for displaying the job narrowing result on the operation display 40 or the like. On the operation screen of FIG. 18, a section of “Configuration” is provided, and “Plural” indicates that a plurality of different pieces of the job paper information are associated with a print job, and “Single” indicates only one piece of the job paper information is associated with a print job. In this example, three different pieces of the job paper information are associated with Job 9.

When the section of “Plural” is selected on the operation screen of FIG. 18, the image forming apparatus 1 displays a new window, such as one indicated as C. In the new window, for example, the image forming apparatus 1 displays a result of determination of the tray paper information that has a highest degree of coincidence with three different pieces of the job paper information, and displays the tray paper information itself. The displayed content is not limited to the above example. When there does not exist the tray paper information at least part of which matches with the job paper information, the image forming apparatus 1 may notify the user about that. The image forming apparatus 1 may then prompt the user to select the paper feeding tray 51 containing paper to be used for outputting a print job associated with the job paper information that does not match with the tray paper information.

As described above, when there is a print job associated with a plurality of different pieces of the job paper information among print jobs narrowed down in the job list, the image forming apparatus 1 according to the third embodiment compares all pieces of the job paper information with the tray paper information. In this manner, even when a plurality of pieces of the job paper information are associated with one print job, the image forming apparatus 1 can display information relating to all pieces of the job paper information, which results in a further improvement in convenience of the user making an attempt to re-output a print job.

The processing of the image forming apparatus 1 according to the above embodiments may include steps other than the steps in the above flowchart, or does not need to include some of the above steps. The order of steps is not limited to those in the embodiments described above. Each step may be executed as one step in combination with other steps, may be executed by being included in other steps, or may be executed by being divided into a plurality of steps.

The means and methods of performing a variety of the processing of the image forming apparatus 1 according to the embodiments described above can be performed by both a dedicated hardware circuit and a programmed computer. The above program may be provided by a computer-readable recording medium, such as a CD-ROM (compact disc read only memory), or may be provided online over a network, such as the Internet. In this case, a program recorded on a computer-readable recording medium is normally transferred to and stored in a memory, such as a hard disk. The above program may be provided as single piece of application software, or may be incorporated in software of the image forming apparatus 1 as a function of the apparatus.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
a paper feeding tray that contains paper; and
a hardware processor that obtains tray paper information that is information of paper set on the paper feeding tray, obtains job paper information from a memory that stores a job list including a plurality of print jobs associated with the job paper information that is information of paper used at the time of output of the print jobs, and narrows down the print jobs in the job list to at least one print job for re-output based on the obtained tray paper information and job paper information.

2. The image forming apparatus according to claim 1, wherein
the hardware processor obtains the tray paper information input by a user on an operation screen.

3. The image forming apparatus according to claim 1, further comprising a sensor that detects the tray paper information, wherein
the hardware processor obtains the tray paper information detected by the sensor.

4. The image forming apparatus according to claim 1, further comprising a tray paper information memory that stores the tray paper information obtained by the hardware processor in association with the paper feeding tray.

5. The image forming apparatus according to claim 1, wherein
the hardware processor narrows down the print jobs in the job list at a timing at which paper is set on the paper feeding tray.

6. The image forming apparatus according to claim 1, wherein
the hardware processor narrows down the print jobs in the job list at a timing at which the paper feeding tray containing paper to be used is selected by a user on an operation screen.

7. The image forming apparatus according to claim 1, wherein
the hardware processor narrows down the print jobs in the job list at a timing at which an operation screen for prompting a user to select a print job to be re-output is displayed.

8. The image forming apparatus according to claim 1, wherein
the hardware processor narrows down the print jobs in the job list based on a job narrowing condition that is a condition for narrowing down the print jobs.

9. The image forming apparatus according to claim 8, wherein
the job narrowing condition is set by a user.

10. The image forming apparatus according to claim 8, wherein
the job narrowing condition includes a condition relating to an attribute of paper to be determined in order to narrow down the print jobs, and
the hardware processor narrows down the print jobs in the job list based on whether or not the attribute of paper to be determined included in the tray paper information and the attribute of paper to be determined included in the job paper information match with each other.

11. The image forming apparatus according to claim 8, wherein
the job narrowing condition includes a condition relating to an attribute of paper to be determined in order to narrow down the print jobs and a condition relating to a threshold value for determination, and
the hardware processor narrows down the print jobs in the job list based on whether or not a difference between a numerical value showing the attribute of paper to be determined included in the tray paper information and a numerical value showing the attribute of paper to be determined included in the job paper information is a predetermined threshold value for determination or smaller.

12. The image forming apparatus according to claim 1, wherein
when there is a plurality of the print jobs narrowed down by the hardware processor, the hardware processor controls so that the narrowed-down print jobs which are rearranged based on a job rearrangement condition that is a condition for rearranging the print jobs are displayed on an operation screen.

13. The image forming apparatus according to claim 12, wherein
the job rearrangement condition is a condition for rearranging the print jobs so that priority is placed on the print jobs stored in association with the job paper information that matches with the tray paper information with a high degree of coincidence.

14. The image forming apparatus according to claim 1, further comprising an output unit that outputs a print job, wherein
the hardware processor further causes the job list stored in the memory to add the print job associated with the job paper information that is at least one piece of information of paper used at the time of output of the print job every time the print job is output by the output unit.

15. The image forming apparatus according to claim 14, wherein
the hardware processor causes the memory to store the job paper information that is at least one piece of information of paper used at the time of re-output of the print job, in association with the re-output print job when the print job is re-output by the output unit.

16. The image forming apparatus according to claim 1, wherein
when there is a print job associated with a plurality of different pieces of the job paper information among the print jobs narrowed down in the job list, the hardware processor compares all pieces of the job paper information with the tray paper information.

17. A method for controlling an image forming apparatus comprising a paper feeding tray that contains paper, comprising:
(a) obtaining tray paper information that is information of paper set on the paper feeding tray;
(b) obtaining job paper information from a memory that stores a job list including a plurality of print jobs associated with the job paper information that is information of paper used at the time of output of the print jobs;
and
(c) narrowing down the print jobs in the job list to at least one print job for re-output based on the tray paper information obtained in the step (a) and the job paper information obtained in the step (b).

18. A non-transitory computer-readable recording medium storing a program that causes a computer to execute the method according to claim 17.
